(19) United States
(12) Patent Application Publication
(10) Pub. No.: US 2025/0251095 A1
(43) Pub. Date: Aug. 7, 2025

(54) FLUID STORAGE APPARATUS

(71) Applicants: HYUNDAI MOTOR COMPANY, Seoul (KR); Kia Corporation, Seoul (KR)

(72) Inventors: Do Hyeon KIM, Hwaseong-si (KR); Woo Jung KWON, Hwaseong-si (KR); Seong Nyeong PARK, Hwaseong-si (KR)

(73) Assignees: HYUNDAI MOTOR COMPANY, Seoul (KR); Kia Corporation, Seoul (KR)

(21) Appl. No.: 18/930,575

(22) Filed: Oct. 29, 2024

(30) Foreign Application Priority Data
Feb. 6, 2024 (KR) 10-2024-0018270

(51) Int. Cl. F17C 13/12

(52) U.S. Cl. CPC F17C 13/123; F17C 2205/0107; F17C 2205/0196; F17C 2205/0388; F17C 2221/012; F17C 2250/0439; F17C 2250/0626; F17C 2270/0168

(57) ABSTRACT

Disclosed is a fluid storage apparatus including a storage part that stores a fluid in an interior thereof, extending along a first direction, and including one or more storage tanks arranged along a second direction being one direction crossing the first direction, and an impact absorbing part that covers at least some of the storage tanks, the impact absorbing part may be configured such that a volume thereof becomes larger in a specific reference condition.

### CROSS-REFERENCE TO RELATED APPLICATION

This application claims the benefit of priority to Korean Patent Application No. 10-2024-0018270, filed in the Korean Intellectual Property Office on Feb. 6, 2024, the entire contents of which are incorporated herein by reference.

### TECHNICAL FIELD

The present disclosure relates to a fluid storage apparatus.

### BACKGROUND

A fuel cell electric vehicle (FCEV) refers to a vehicle that is driven by supplying electric power to an electric motor with a fuel cell. The FCEV uses hydrogen as a fuel. Accordingly, to use hydrogen as a fuel, the hydrogen is filled in a hydrogen storage tank. Recently, to reduce space dependence, a form of a miniaturized hydrogen storage tank with a plurality of small-diameter hydrogen storage tanks, which is connected to one manifold, has been developed.

Meanwhile, researches have recently been conducted on technology for utilizing electric vehicle platforms as FCEV platforms. To provide a hydrogen storage apparatus in a space that is occupied by an existing battery pack of an electric vehicle platform, a structure, in which a plurality of hydrogen storage tanks are long in length and small in diameter are disposed, is required.

However, when a plurality of small-diameter, long-axis hydrogen storage tanks are disposed, the length becomes larger whereby it is vulnerable to impacts that may occur from a side surface of the vehicle.

In addition, a thermally activated pressure relief device (TPRD) is installed in the hydrogen storage tank of the FCEV for safety in the event of a fire, and when a plurality of small-diameter, long-axis hydrogen storage tanks are disposed, an area thereof becomes larger than before and thus, an area, in which the temperature-sensitive safety valve does not respond, may be formed.

### SUMMARY

The present disclosure has been made to solve the above-mentioned problems occurring in the prior art while advantages achieved by the prior art are maintained intact.

An aspect of the present disclosure provides a fluid storage apparatus that may absorb an impact from a side collision.

An aspect of the present disclosure also provides a fluid storage apparatus that may extinguish a fire that occurs on a lower side.

The technical problems to be solved by the present disclosure are not limited to the aforementioned problems, and any other technical problems not mentioned herein will be clearly understood from the following description by those skilled in the art to which the present disclosure pertains.

In one embodiment, a fluid storage apparatus includes a storage part that stores a fluid in an interior thereof, extending along a first direction, and including one or more storage tanks arranged along a second direction being one direction crossing the first direction, and an impact absorbing part that covers a portion of the one or more storage tanks, the impact absorbing part may be configured such that a volume thereof becomes larger in a specific reference condition.

In another example, a direction being perpendicular to the first direction and the second direction is defined as a third direction, and an imaginary plane including centers of the one or more storage tanks and being perpendicular to the third direction is defined as a reference plane, an area, in which the impact absorbing part covers any one of the one or more storage tanks, may be located in any one of the third direction of the reference plane or an opposite direction thereto, and an area covering another of the one or more storage tanks being adjacent to the any one of the one or more storage tanks may be located in the other one of the third direction of the reference plane or the opposite direction thereto.

In another example, the impact absorbing part may further include an impact absorbing portion at least partially covering the one or more storage tanks, and an expanded portion connected to at least any one of the impact absorbing portion in the second direction or an opposite direction thereto, and that changes the volume of the impact absorbing portion in the reference condition.

In another example, the impact absorbing part may further include a first reaction capsule disposed in an interior of the expanded portion, and in which a first reactant is disposed in an interior of the first reaction capsule, and a second reactant that generates a reference gas while reacting with the first reactant, and the reference gas may be introduced into the impact absorbing portion to increase the volume of the impact absorbing portion.

In another example, the impact absorbing part may further include a damaging portion disposed in an interior of the expanded portion, and that damages the first reaction capsule in the reference condition.

In another example, the fluid storage apparatus of claim 5, may further include a protective part disposed adjacent to a side of the one or more storage tanks in at least one of the second direction and an opposite direction thereto, and the expanded portion is disposed in an interior of the protective part.

In another example, the impact absorbing part may include a connection part connecting the impact absorbing portion and the expanded portion, and wherein the protective part may include a through-hole, through which the connection part passes.

In another example, the fluid storage apparatus may further include at least one impact sensor part coupled to the protective part, and that senses an impulse applied to the protective part, and a controller electrically connected to the impact sensor part and configured to acquire information sensed by the impact sensor part, the controller being electrically connected to the damaging portion to control an operation of the damaging portion, and the controller may damage the first reaction capsule by operating the damaging portion when an impulse detected by an impact reference number or more of impact sensor parts is a reference impulse or more.

In another example, the protective part may include a protective part body, and an impact absorbing member coupled to a surface of the protective part body, which faces the one or more storage tanks, and that absorbs an impact applied to the one or more storage tanks.

In another example, a pair of protective part bodies may be provided to be disposed adjacent to sides of the storage tanks in the second direction and an opposite direction thereto, respectively, and the protective part may further include a first connection member extending along the second direction, and connecting sides of the pair of protective part bodies in the third direction, and a second connection member extending along the second direction, and connecting sides of the pair of protective part bodies in an opposite direction to the third direction.

In another example, the fluid storage apparatus may further include a fire resistant part located on a lower side of the one or more storage tanks, and covering the lower side of the one or more storage tanks, at least one temperature sensor part coupled to the fire resistant part, and that senses information on an ambient temperature, and a controller electrically connected to the temperature sensor part and configured to acquire information sensed by the temperature sensor part, the controller being electrically connected to the damaging portion to control an operation of the damaging portion, and the controller may damage the first reaction capsule by operating the damaging portion when a temperature detected by a temperature reference number of temperature sensor parts is a reference temperature or more.

In another example, the impact absorbing part may further include a fire extinguishing capsule disposed in an interior of the impact absorbing portion, which is located on a lower side of the reference plane, and including a fire extinguishing agent for extinguishing fire in an interior thereof.

In another example, the impact absorbing portion may be formed of a material having a first melting temperature, and the fire extinguishing capsule may be formed of a material being having a second melting temperature greater than the first melting temperature.

In another example, the fluid storage apparatus may further include a fire resistant part located on a lower side of the storage tanks, and covering the lower side of the storage tanks, and a passing hole extends through the fire resistant part in an upward/downward direction, and is configured such that the fire extinguishing capsule is passable therethrough.

In another example, the passing hole may be shaped such that a size tapers torwards a lower side.

In another example, a length of the impact absorbing part along the first direction may be less than a length of the one or more storage tanks along the first direction.

In another example, the one or more storage tanks may include outlets on sides thereof in the first direction and a direction opposite thereto, and the storage part may further include a manifold coupled to outlets of the one or more storage tanks in the first direction, and an interior of which is communicated to interiors of the one or more storage tanks, a bracket coupled to outlets of the one or more storage tanks in a direction opposite to the first direction, the bracket configured to allow expansion of the one or more storage tanks in the direction opposite to the first direction, and an interior of the bracket is communicated with the interiors of the one or more storage tanks, and a thermally activated pressure relief device connected to at least one of the manifold and the bracket.

In another example, the fluid storage apparatus may further include a regulator connected to the storage part, and that reduces a pressure of a fluid in the one or more storage tanks, which is discharged from the one or more storage tanks, a fluid supply system connected to the regulator and that receives the fluid from the regulator and supplies the fluid to a stack, a fluid supply pipeline connecting the fluid supply system and the stack, a fluid branch pipeline branched from the fluid supply pipeline and connected to the impact absorbing part, and a fluid opening/closing valve that opens and closes the fluid branch pipeline.

In another example, the impact absorbing part may be a material coated for an anti-static effect.

In another example, the fluid storage apparatus may further include a compressor that compresses air introduced from an outside, a cooler that cools the air discharged from the compressor, an air supply pipeline connecting the compressor and the cooler, an air branch pipeline branched from the air supply pipeline and connected to the impact absorbing part, and an air opening/closing valve that opens and closes the air branch pipeline, and a plurality of holes may be formed on an outer surface of the impact absorbing part.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a fluid storage apparatus according to a first embodiment of the present disclosure;

FIG. 2 is a view illustrating a fluid storage apparatus according to a first embodiment of the present disclosure, viewed from a top;

FIG. 3 is a view illustrating a fluid storage apparatus according to a first embodiment of the present disclosure, viewed from a first direction;

FIG. 4 is a view illustrating a fluid storage apparatus according to a first embodiment of the present disclosure, viewed from a bottom;

FIG. 5 is a view illustrating a storage part;

FIG. 6 is a view illustrating an impact absorbing part;

FIG. 7 is an enlarged view of a dotted line portion of FIG. 6;

FIG. 8 is a view conceptually illustrating an expanded portion;

FIG. 9 is a view illustrating a state, in which a storage part, an impact absorbing part, and a protective part are coupled to each other;

FIG. 10 is a view illustrating a first fire extinguishing capsule;

FIG. 11 is a perspective view illustrating a protective part;

FIG. 12 is a view illustrating a protective part, viewed along a first direction;

FIG. 13 is a view illustrating FIG. 11, taken along line A-A′;

FIGS. 14A and 14B are views illustrating a fire resistant part;

FIG. 15 is a view illustrating a manifold connected to a storage part, and a thermally activated pressure relief device;

FIG. 16 is a view illustrating a bracket coupled to a storage part, and a thermally activated pressure relief device;

FIG. 17 is a flowchart illustrating an operation of a fluid storage apparatus according to a first embodiment of the present disclosure;

FIG. 18 is a view conceptually illustrating a fluid storage apparatus according to a second embodiment of the present disclosure; and

FIG. 19 is a view conceptually illustrating a fluid storage apparatus according to a third embodiment of the present disclosure.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

A fluid storage apparatus according to an embodiment of the present disclosure may be a fluid storage apparatus that is used in a fuel cell electric vehicle (FCEV). As an example, a fluid may be hydrogen. However, the present disclosure is not limited thereto, and is not limited as long as it is a fluid that may be used as a fuel.

In the specification, a forward/rearward direction, a leftward/rightward direction, an upward/downward direction, and a vertical direction are referred for convenience of description, and may be directions that are perpendicular to each other. However, the directions are determined relative to a direction, in which the fluid storage apparatus is arranged, and the upward/downward direction may not necessarily mean the vertical direction.

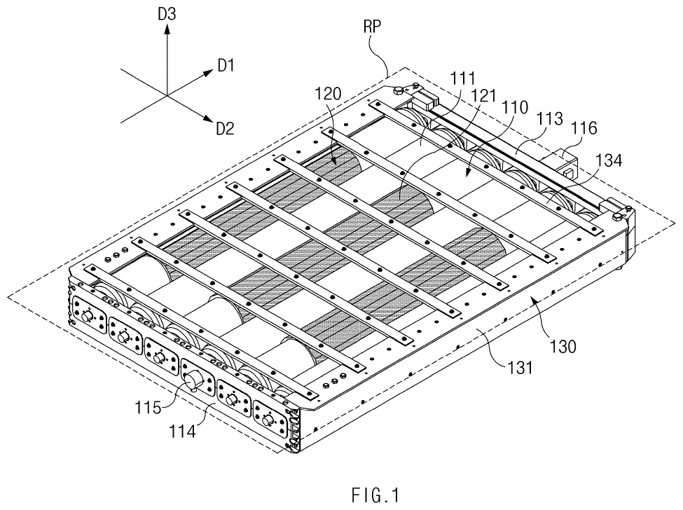

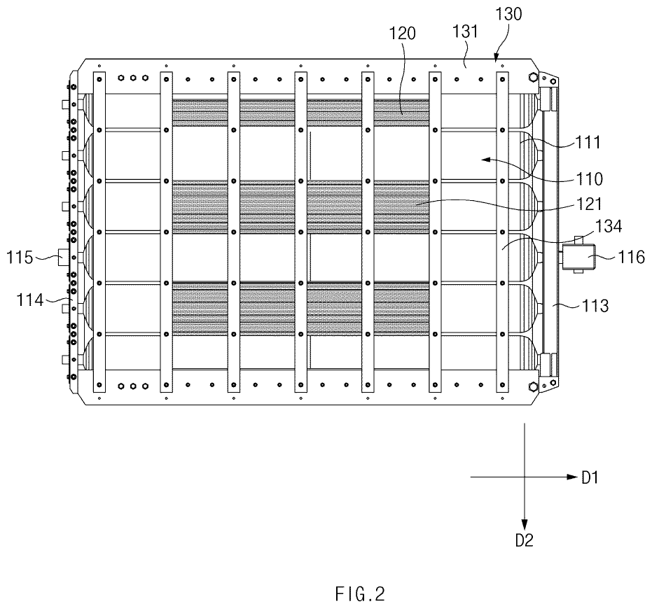

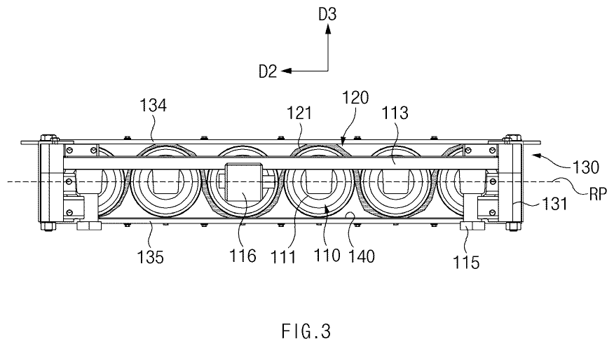

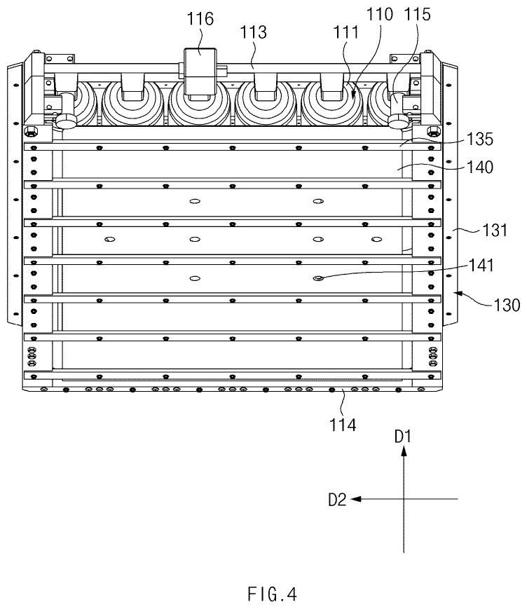

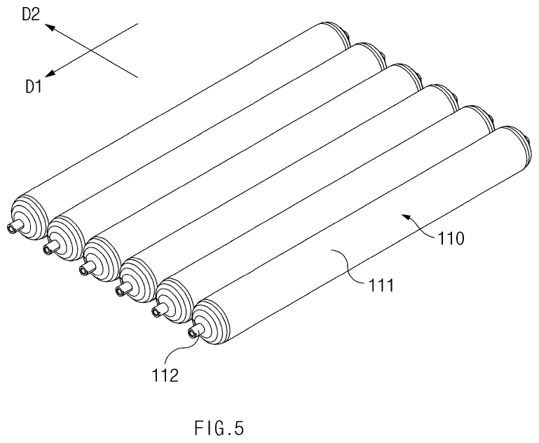

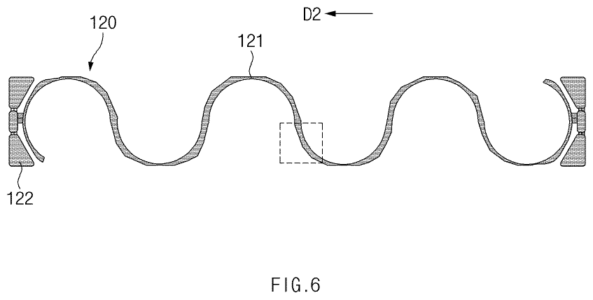

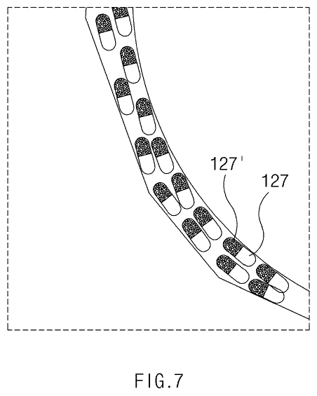

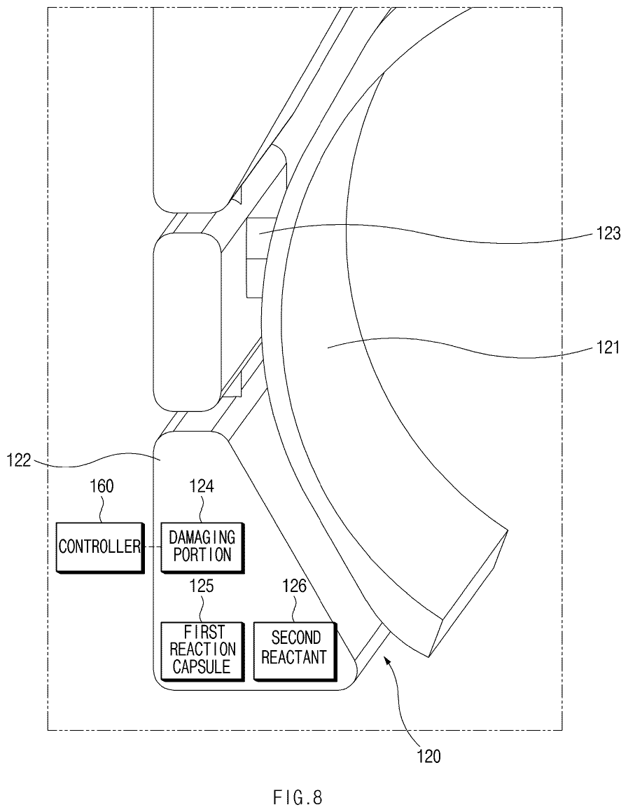

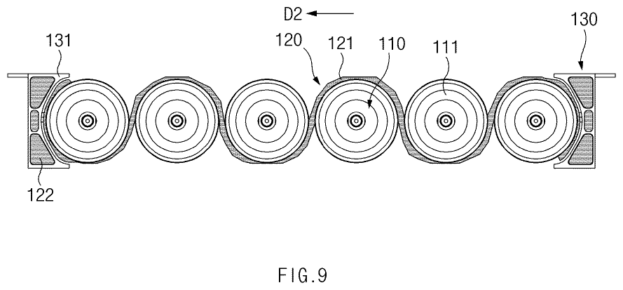

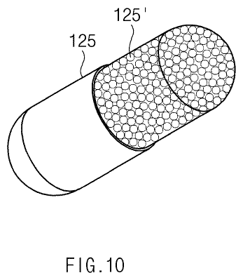

FIG. 1 is a perspective view of a fluid storage apparatus according to a first embodiment of the present disclosure. FIG. 2 is a view illustrating the fluid storage apparatus according to the first embodiment of the present disclosure, viewed from a top. FIG. 3 is a view illustrating the fluid storage apparatus according to the first embodiment of the present disclosure, viewed from the first direction. FIG. 4 is a view illustrating the fluid storage apparatus according to the first embodiment of the present disclosure, viewed from a bottom. FIG. 5 is a view illustrating a storage part. FIG. 6 is a view illustrating an impact absorbing part. FIG. 7 is an enlarged view of a dotted line portion of FIG. 6. FIG. 8 is a view conceptually illustrating an expanded portion. FIG. 9 is a view illustrating a state, in which the storage part, the impact absorbing part, and a protective part are coupled to each other. FIG. 10 is a view illustrating a first fire extinguishing capsule.

### First Embodiment

A fluid storage apparatus according to the first embodiment of the present disclosure may include a storage part 110 and an impact absorbing part 120. The storage part 110 may include one or more storage tanks 111. The storage tanks 111 may be configured to store a fluid in an interior thereof, and may extend along a first direction D1. The first direction D1 may be a forward direction of a vehicle. The storage tanks 111 may be disposed along a second direction D2 that is one direction that crosses the first direction D1.

A third direction D3 may be a direction that is perpendicular to the first direction D1 and the second direction D2. The third direction D3 may be an upward direction.

The impact absorbing part 120 may be configured to cover at least some of the storage tanks 111. The impact absorbing part 120 may be configured such that a volume thereof expands in a specific reference condition. The reference condition may be a condition, in which it is determined that an impact has been applied to the vehicle. As the impact absorbing part 120 is expanded, the impact applied to the storage tanks 111 may be absorbed. As an example, the impact absorbing part 120 may be an airbag.

Hereinafter, for convenience of description, an imaginary plane that includes the centers of the storage tanks 111 and is perpendicular to the third direction D3 is referred to as a reference plane RP. The reference plane RP may be understood as a plane that cuts the plurality of storage tanks 111 in half. The reference plane RP may extend through the centers of each of the storage tanks 111.

An area, in which the impact absorbing part 120 covers any one storage tank 111, may be located in any one of the third direction D3 of the reference plane RP or an opposite direction thereto. An area that covers another storage tank 111 that is adjacent to the any one storage tank 111 may be located in any one of the third direction D3 of the reference plane RP or the opposite direction thereto. In some embodiments, a position in which the impact absorbing part 120 covers the storage tank 111 is alternately changed along the second direction D2. A length of the impact absorbing part 120 along the first direction D1 may be smaller than lengths of the storage tank 111 along the first direction D1.

The impact absorbing part 120 may include an impact absorbing portion 121 and an expanded portion 122. The impact absorbing portion 121 may be a portion that covers the storage tanks 111. The expanded portion 122 may be connected to at least any one of opposite ends of the impact absorbing portion 121 in the second direction D2 or an opposite direction thereto, and may be configured to change the volume of the impact absorbing portion 121 in the reference condition.

The impact absorbing part 120 may further include a first reaction capsule 125 and a second reactant 126. The first reaction capsule 125 may be disposed in an interior of the expanded portion 122, and a first reactant 125′ may be disposed in the interior thereof. The first reactant 125′ may be sodium azide (NaN3). In the reference condition, a damaging portion 124 that will be described later may be ignited to damage the first reaction capsule 125.

The second reactant 126 may be configured to react with the first reactant 125′ to generate a reference gas. The second reactant 126 may be iron oxide (Fe₂O₃). Furthermore, the reference gas may be nitrogen. The reference gas may be introduced into the impact absorbing portion 121 to increase the volume of the impact absorbing portion 121.

The impact absorbing part 120 may further include a damaging portion 124. The damaging portion 124 may be disposed in an interior of the expanded portion 122, and may be configured to damage the first reaction capsule 125 in the reference condition. As an example, the damaging portion 124 may be an igniter that is ignited by electric current. When the damaging portion 124 corresponds to the reference condition, it may generate sparks and damage the first reaction capsule 125. Because a detailed operation principle of this is similar to that of a common airbag, a detailed description thereof will be omitted.

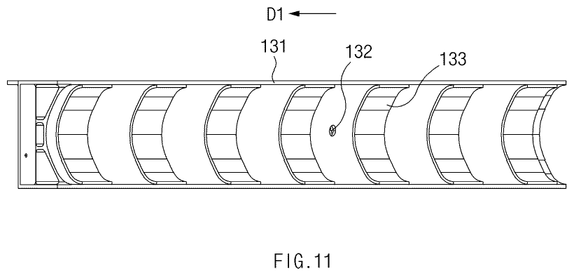

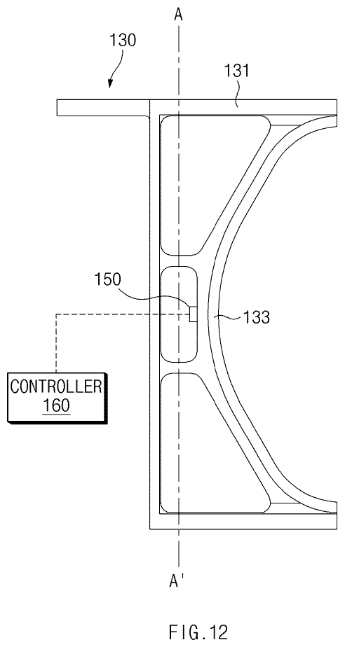

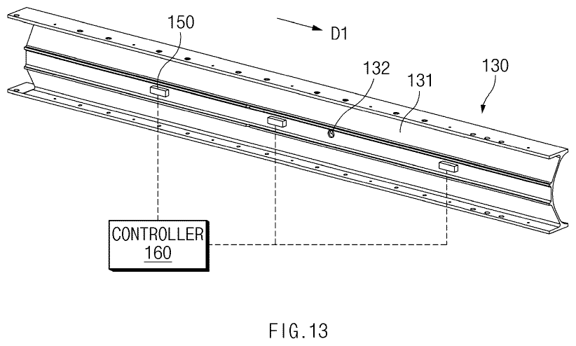

FIG. 11 is a perspective view illustrating a protective part. FIG. 12 is a view illustrating the protective part, viewed along the first direction. FIG. 13 is a view illustrating FIG. 11, taken along line A-A′.

The fluid storage apparatus according to the first embodiment of the present disclosure may further include a protective part 130. The protective part 130 may be disposed adjacent to at least one of the second direction D2 of the storage tank 111 or an opposite direction thereto, and the expanded portion 122 may be disposed in an interior thereof. The protective part 130 may be a configuration for protection against an impact that is applied to a side surface of the storage tank 111. Furthermore, the protective part 130 may protect the expanded portion 122 from the impact applied thereto, and prevent a malfunction of the damaging portion 124.

The protective part 130 may include a protective part body 131 and an impact absorbing member 133. The impact absorbing member 133 may be coupled to a surface of the protective part body 131, which faces the storage tanks 111, to absorb the impact applied to the storage tanks 111. The surface of the protective part body 131, faces the storage tanks 111, may have a shape that corresponds to and is engaged with the shapes of the storage tanks 111. A plurality of impact absorbing members 133 may be provided to be arranged along the first direction D1.

A pair of protective part bodies 131 may be provided, and may be disposed adjacent to sides of the storage tanks 111 in the second direction D2 and the opposite direction thereto, respectively. The protective part 130 may include a first connection member 134 and a second connection member 135. The first connection member 134 may extend along the second direction D2, and may connect sides of the pair of protective part bodies 131 in the third direction D3. The second connection member 135 may extend along the second direction D2, and connect sides of the pair of the protective part bodies 131 in an opposite direction to the third direction D3. A plurality of first connection members 134 and a plurality of second connection members 135 may be provided, and may be arranged along the first direction D1.

The impact absorbing part 120 may include a connection part 123 that connects the impact absorbing portion 121 and the expanded portion 122. The protective part 130 may include a through-hole 132, through which the connection part 123 passes. The through-hole 132 may be formed in the protective part body 131. In the reference condition, the expanded portion 122 may damage the first reaction capsule 125, and the reference gas may be injected into the impact absorbing portion 121 through the connection part 123.

Hereinafter, an operation of the fluid storage apparatus according to the first embodiment of the present disclosure for expanding the impact absorbing portion 121 based on an externally applied impact will be described in detail. This may be an operation when an impact, such as a collision, is applied to the vehicle.

The fluid storage apparatus according to the first embodiment of the present disclosure may further include an impact sensor part 150 and a controller 160. The impact sensor part 150 may be coupled to the protective part 130 to sense an impulse that is applied to the protective part 130. At least one impact sensor part 150 may be provided.

The controller 160 may be electrically connected to the impact sensor part 150 to acquire information that is sensed by the impact sensor part 150. Furthermore, the controller 160 may be electrically connected to the damaging portion 124 to control an operation of the damaging portion 124.

The controller 160 may include a processor and memory. The processor may include a microprocessor, such as a field programmable gate array (FPGA), an application specific integrated circuit (ASIC), or a central processing unit (CPU). The memory may store control instructions that are the basis for the processor to generate instructions for determining whether the damaging portion 124 is operated. The memory may be a data storage, such as a hard disk drive (HDD), a solid state drive (SSD), a volatile medium, or a non-volatile medium.

The controller 160 may damage the first reaction capsule 125 by operating the damaging portion 124 when the impulse detected by an impact reference number or more of impact sensor parts 150 is a reference impulse. The impact reference number may be a value that is smaller than a total number of impact sensor parts 150.

This may mean that the reference condition is a case, in which the impulse detected by the impact sensor part 150 is the reference impulse or more. For example, when three entire impact sensor parts 150 are coupled to the pair of protective parts 130 and the impact reference number is two, the controller 160 may operate the damaging portion 124 when the impulse detected by two or more impact sensor parts 150 are greater than the reference impulse to increase the volume of the impact absorbing portion 121.

Hereinafter, an operation of the fluid storage apparatus according to the first embodiment of the present disclosure for expanding the impact absorbing portion 121 based on an external temperature will be described in detail. This may be an operation in an event of a fire in the vehicle.

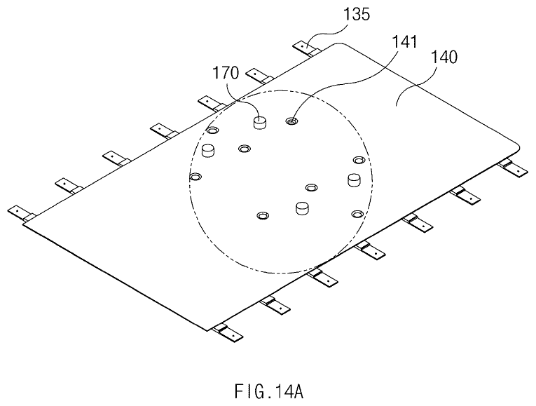

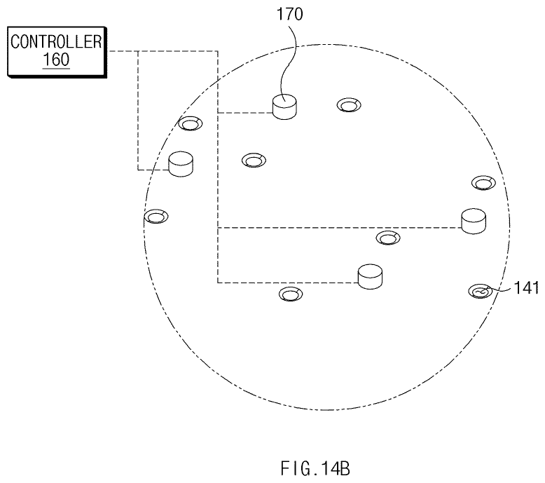

FIGS. 14A and 14B are views illustrating a fire resistant part. The fluid storage apparatus according to the first embodiment of the present disclosure may further include a fire resistant part 140 and a temperature sensor part 170. The fire resistant part 140 may be a part that is located on a lower side of the storage tanks 111 and covers the lower side of the storage tanks 111. The temperature sensor part 170 may be coupled to the fire resistant part 140, and may be configured to sense information on an ambient temperature. At least one temperature sensor part 170 may be provided. As an example, the temperature sensor part 170 may be coupled to an upper surface of the fire resistant part 140.

The controller 160 may be electrically connected to the temperature sensor part 170 to acquire information sensed by the temperature sensor part 170. When the temperature that is detected by a temperature reference number of temperature sensor parts 170 is a reference temperature or higher, the controller 160 may damage the first reaction capsule 125 by operating the damaging portion 124. The temperature reference number may be a value that is smaller than a total number of the temperature sensor parts 170.

This may mean that the reference condition is a case, in which the temperature that is sensed by the temperature sensor part 170 is the reference temperature or higher. For example, a total of four temperature sensor parts 170 are provided and a temperature reference number is three, the controller 160 may operate the damaging portion 124 when the temperature that is detected by the three or more temperature sensor parts 170 is a reference temperature or higher to increase the volume of the impact absorbing portion 121.

Meanwhile, the reference condition may be applied in parallel to the case of the impact sensor part 150. For example, even when the impulse sensed by the impact reference number or more of impact sensor parts 150 is not the reference impulse, the controller 160 may operate the damaging portion 124 when the temperature detected by a temperature reference number or more of temperature sensor part 170 is the reference temperature or higher.

Meanwhile, when a fire occurs in the vehicle, it is necessary to extinguish the fire to prevent damage to the storage tanks 111. In particular, when such a fire occurs below the fluid storage apparatus, there is a risk of the storage tanks 111 being damaged and an internal fluid exploding as a result. Hereinafter, a structure for extinguishing a fire that occurs below the fluid storage apparatus will be described in detail.

The impact absorbing part 120 may further include a fire extinguishing capsule 127 (FIG. 7). The fire extinguishing capsule 127 may be disposed in interiors of at least some of areas that is located on a lower side of the reference plane RP of the impact absorbing portion 121. The fire extinguishing agent 127′ for extinguish a fire may be disposed in an interior of the fire extinguishing capsule 127. As an example, the fire extinguishing agent 127′ may be ammonium phosphate (NH₄H₂PO₄).

The impact absorbing portion 121 may be formed of a material that is melted at a first temperature, and the fire extinguishing capsule 127 may be formed of a material that is melted at a second temperature that is higher than the first temperature. For example, the impact absorbing portion 121 is formed of a material having a first melting temperature and the fire extinguishing capsule 127 is formed of a material having a second melting temperature that is greater than the first melting temperature. Then, the first temperature may be a temperature that is higher than the reference temperature. As an example, the first temperature may be 110 degrees Celsius, and the second temperature may be 600 degrees Celsius.

Meanwhile, a passing hole 141 may be formed in the fire resistant part 140. The passing hole 141 may be configured to pass through in the upward/downward direction such that the fire extinguishing capsule 127 passes therethrough. That is, the fire extinguishing capsule 127 disposed in an interior of the impact absorbing portion 121 may pass through the passing hole 141 of the fire resistant part 140 to be guided to a portion, at which a fire occurs. The guided fire extinguishing capsule 127 may be melted at the second temperature, and the fire extinguishing agent 127′ in an interior thereof may extinguish the fire.

Meanwhile, the passing hole 141 may have a shape, a size of which becomes smaller as it goes downward. This may be for having an advantageous structure for preventing inflow of flames that come from a lower side and guiding the fire extinguishing agent 127′ located on an upper side of the fire resistant part 140 to the lower side.

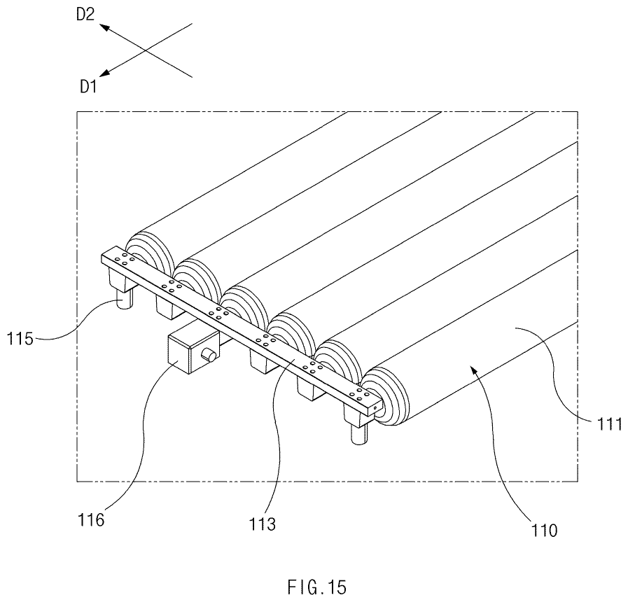

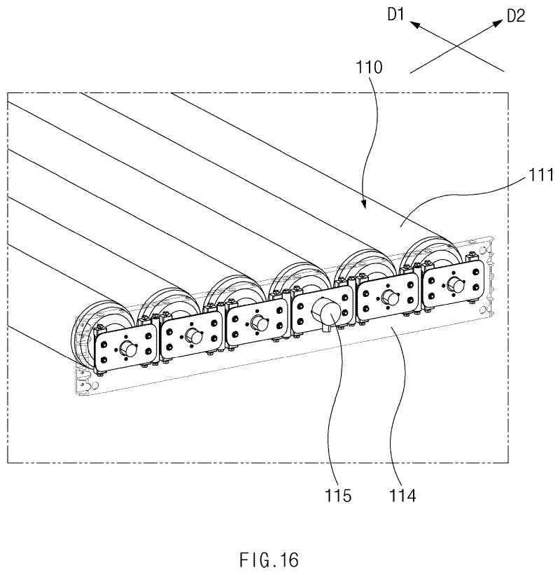

FIG. 15 is a view illustrating a manifold coupled to the storage part, and a thermally activated pressure relief device. FIG. 16 is a view illustrating a bracket coupled to the storage part and the thermally activated pressure relief device.

Hereinafter, a structure that may be further provided to the fluid storage apparatus according to the first embodiment of the present disclosure will be described in detail. The storage tanks 111 may have outlets 112 in the first direction D1 and the opposite direction thereto, respectively.

The storage part 110 may further include a manifold 113, a bracket 114, and a thermally activated pressure relief device 115. The manifold 113 may be coupled to the outlets 112 of the storage tanks 111 in the first direction D1, and the interiors of the storage tanks 111 may be communicated with each other. A solenoid valve 116 for discharging the fluid may be coupled to the manifold 113.

The bracket 114 may be coupled to the outlets 112 in the opposite direction to the first direction D1 of the storage tanks 111 and may be configured to allow the storage tanks 111 to be expanded in the opposite direction to the first direction D1. An interior of the bracket 114 may be communicated with the interiors of the storage tanks 111.

The thermally activated pressure relief device 115 may be a valve that is opened to discharge the fluid in the interiors of the storage tanks 111 at a specific temperature. The thermally activated pressure relief device 115 may be connected to at least any one of the manifold 113 or the bracket 114.

As an example, the thermally activated pressure relief device 115 may be connected to opposite ends of the manifold 113 in the second direction D2 and the opposite direction thereto, and may be coupled adjacent to a center of the bracket 114.

As another example, the thermally activated pressure relief device 115 may be connected to opposite ends of the manifold 113 in the second direction D2 and the opposite direction thereto, and may be connected to opposite ends of the bracket 114 in the second direction D2 and the opposite direction thereto.

As another example, the thermally activated pressure relief device 115 may be connected to opposite ends of the manifold 113 in the second direction D2 and the opposite direction thereto.

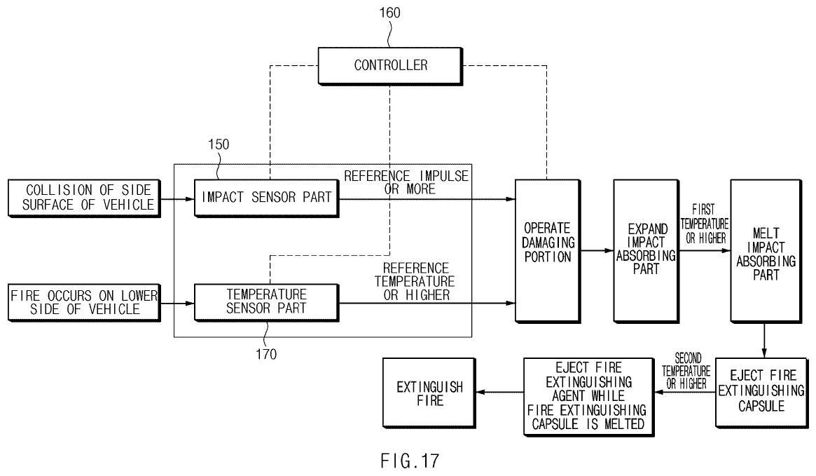

FIG. 17 is a flowchart illustrating an operation of the fluid storage apparatus according to the first embodiment of the present disclosure. Hereinafter, the operation of the fluid storage apparatus according to the first embodiment of the present disclosure will be described in detail based on FIG. 17 and the foregoing contents.

First, the controller 160 may operate the damaging portion 124 in the reference condition. Then, the reference condition may mean that a collision occurs on a side surface of the vehicle and the impulse detected by an impact reference number or more of impact sensor part 150 is a reference impulse or more, or a fire occurs on a lower side of the fluid storage apparatus and the reference condition corresponds to a case, in which the temperature detected by a temperature reference number or more of temperature sensor parts 170 is a reference temperature or higher.

The operated damaging portion 124 damages the first reaction capsule 125, and the first reactant 125′ that exits from the damaged first reaction capsule 125 reacts with the second reactant 126 to generate a reference gas. The generated reference gas flows to the impact absorbing portion 121 and expands the impact absorbing portion 121.

Meanwhile, when the temperature of the portion that is located on the lower side of the storage tanks 111 of the impact absorbing portion 121 becomes a first temperature or higher due to a fire, the portion is melted, and the fire extinguishing capsule 127 falls downward.

The dropped fire extinguishing capsule 127 passes through the passing hole 141 via the fire resistant part 140 and heads to the fire position. Then, when the temperature of the fire extinguishing capsule 127 is the second temperature or higher, the fire extinguishing capsule 127 may be melted, and the fire extinguishing agent 127′ in an interior of the fire extinguishing capsule 127 may extinguish the fire.

### Second Embodiment

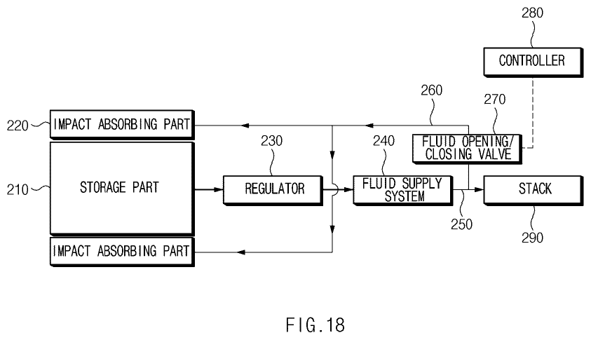

FIG. 18 is a view conceptually illustrating a fluid storage apparatus according to a second embodiment of the present disclosure. Hereinafter, the fluid storage apparatus according to the second embodiment of the present disclosure will be described with reference to FIG. 18. The fluid storage apparatus according to the second embodiment differs from the fluid storage apparatus according to the first embodiment in a method of expanding an impact absorbing part 220. The components that are identical or equivalent to those of the fluid storage apparatus according to the first embodiment are assigned the same or equivalent reference numerals, and a detailed description thereof will be omitted.

The fluid storage apparatus according to the second embodiment may further include a regulator 230, a fluid supply system 240, a fluid supply pipeline 250, a fluid branch pipeline 260, and a fluid opening/closing valve 270. The fluid may be hydrogen.

The regulator 230 may be connected to a storage part 210 to reduce a pressure of the fluid in the storage part 210, which is discharged from the storage part 210. The fluid supply system (FPS) 240 may be connected to the regulator 230 to receive the fluid from the regulator 230 and supply the fluid to the stack 290. The fluid supply pipeline 250 may connect the fluid supply system 240 and the stack 290. The fluid branch pipeline 260 may be branched from the fluid supply pipeline 250 and may be connected to the impact absorbing part 220. The fluid opening/closing valve 270 may be configured to open and close the fluid branch pipeline 260. The controller 280 may open the fluid branch pipeline 260 by controlling the fluid opening/closing valve 270 in the reference condition. In the reference condition, air may be introduced into the impact absorbing part 220 through the fluid branch pipeline 260 whereby the impact absorbing part 220 may protect the storage part 210.

The impact absorbing part 220 of the fluid storage apparatus according to the second embodiment may be a material that is coated for an anti-static effect. As the impact absorbing part 220 uses a material coated for an anti-static effect, a reaction of the impact absorbing part 220 and the fluid may be disturbed.

In the case of the fluid storage apparatus according to the second embodiment, the impact absorbing part 220 may be expanded without any component, such as a separate damaging portion 124, the first reaction capsule 125, or the second reactant 126.

### Third Embodiment

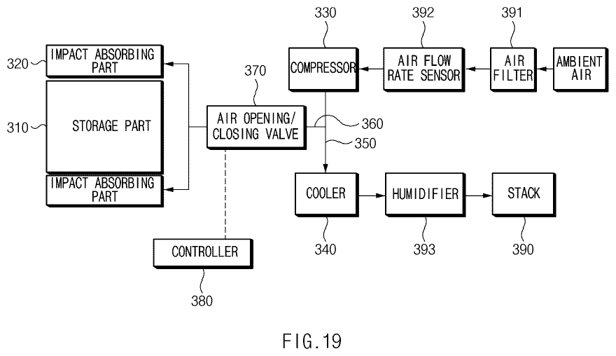

FIG. 19 is a view conceptually illustrating a fluid storage apparatus according to a third embodiment of the present disclosure. Hereinafter, the fluid storage apparatus according to the third embodiment of the present disclosure will be described with reference to FIG. 19. The fluid storage apparatus according to the third embodiment differs from the fluid storage apparatus according to the first embodiment in a method of expanding an impact absorbing part 320. The components that are identical or equivalent to those of the fluid storage apparatus according to the first embodiment are assigned the same or equivalent reference numerals, and a detailed description thereof will be omitted.

The fluid storage apparatus according to the third embodiment may further include a compressor 330, a cooler 340, an air supply pipeline 350, an air branch pipeline 360, and an air opening/closing valve 370. The compressor 330 may be configured to compress air that is introduced from an outside. An air filter 391 and an air flow rate sensor 392 may be disposed on an upstream side of the compressor 330.

The cooler 340 may be configured to cool the air that is discharged from the compressor 330. A humidifier 393 may be disposed on a downstream side of the cooler.

The air supply pipeline 350 may connect the compressor 330 and the cooler 340. The air branch pipeline 360 branches off from the air supply pipeline 350 and may be connected to the impact absorbing part 320. The air opening/closing valve 370 may be configured to open and close the air branch pipeline 360. The controller 380 may open the air branch pipeline 360 by controlling the air opening/closing valve 370 in the reference condition. In the reference condition, the air may be introduced into the impact absorbing part 320 through the air branch pipeline 360 whereby the impact absorbing part 320 may protect the storage part 310.

In the case of the fluid storage apparatus according to the third embodiment, the impact absorbing part 320 may be expanded without any component, such as a separate damaging portion, the first reaction capsule, or the second reactant.

Meanwhile, because a pressure at a rear end of the compressor 330 is approximately 2.1 bar, there is a risk of the impact absorbing part 320 being damaged when the air at the rear end of the compressor 330 continues to be introduced into the impact absorbing part 320. Accordingly, a plurality of fine holes may be formed on an outer surface of the impact absorbing part 320. Because the air in an interior of the impact absorbing part 320 may be discharged through the fine holes, an internal pressure of the impact absorbing part 320 may also be maintained at about 2.1 bar.

According to the present disclosure, the impact absorbing part that surrounds the hydrogen tank may be operated based on the impulse generated by a side collision of the vehicle whereby the impact caused by the side collision of the vehicle may be absorbed.

In addition, according to the present disclosure, the fire extinguishing agent may be released to the lower side based on the temperature whereby a fire that occurs on the lower side may be extinguished.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A fluid storage apparatus comprising:
a storage part configured to store a fluid in an interior thereof, extending along a first direction, and including one or more storage tanks arranged along a second direction being one direction crossing the first direction; and
an impact absorbing part configured to cover at least a portion of the one or more storage tanks,
wherein the impact absorbing part is configured such that a volume thereof becomes larger in a reference condition.

2. The fluid storage apparatus of claim 1, wherein when a direction being perpendicular to the first direction and the second direction is defined as a third direction, and
wherein an imaginary plane including centers of the one or more storage tanks and being perpendicular to the third direction is defined as a reference plane,
wherein an area in which the impact absorbing part covers any one of the one or more storage tanks, is located in any one of the third direction of the reference plane or an opposite direction thereto, and
wherein an area in which the impact absorbing part covers another of the one or more storage tank being adjacent to the any one of the one or more storage tanks is located in the other one of the third direction of the reference plane or the opposite direction thereto.

3. The fluid storage apparatus of claim 1, wherein the impact absorbing part includes:
an impact absorbing portion at least partially covering the one or more storage tanks; and
an expanded portion connected to the impact absorbing portion in at least one of the second direction and an opposite direction thereto, and configured to change the volume of the impact absorbing portion in the reference condition.

4. The fluid storage apparatus of claim 3, wherein the impact absorbing part further includes:
a first reaction capsule disposed in an interior of the expanded portion, and in which a first reactant is disposed in an interior of the first reaction capsule; and
a second reactant configured to generate a reference gas while reacting with the first reactant, and
wherein the reference gas is configured to be introduced into the impact absorbing portion to increase the volume of the impact absorbing portion.

5. The fluid storage apparatus of claim 4, wherein the impact absorbing part further includes:
a damaging portion disposed in an interior of the expanded portion, and configured to damage the first reaction capsule in the reference condition.

6. The fluid storage apparatus of claim 5, further comprising:
a protective part disposed adjacent to a side of the one or more storage tanks in at least one of the second direction and an opposite direction thereto, and the expanded portion is disposed in an interior of the protective part.

7. The fluid storage apparatus of claim 6, wherein the impact absorbing part includes:
a connection part connecting the impact absorbing portion and the expanded portion, and
wherein the protective part includes a through-hole, through which the connection part passes.

8. The fluid storage apparatus of claim 6, further comprising:
at least one impact sensor part coupled to the protective part and configured to sense an impulse applied to the protective part; and
a controller electrically connected to the impact sensor part and configured to acquire information sensed by the impact sensor part, the controller being electrically connected to the damaging portion to control an operation of the damaging portion, and
wherein the controller is configured to:
damage the first reaction capsule by operating the damaging portion when an impulse detected by an impact reference number or more of impact sensor parts is a reference impulse or more.

9. The fluid storage apparatus of claim 6, wherein the protective part includes:
a protective part body; and
an impact absorbing member coupled to a surface of the protective part body, which faces the one or more storage tanks, and configured to absorb an impact applied to the one or more storage tanks.

10. The fluid storage apparatus of claim 9, wherein a pair of protective part bodies are provided to be disposed adjacent to sides of the storage tanks in the second direction and an opposite direction thereto, respectively, and
wherein the protective part further includes:
a first connection member extending along the second direction, and connecting sides of the pair of protective part bodies in the third direction; and
a second connection member extending along the second direction, and connecting sides of the pair of protective part bodies in an opposite direction to the third direction.

11. The fluid storage apparatus of claim 5, further comprising:
a fire resistant part located on a lower side of the one or more storage tanks, and covering the lower side of the one or more storage tanks;
at least one temperature sensor part coupled to the fire resistant part, and configured to sense information on an ambient temperature; and
a controller electrically connected to the temperature sensor part and configured to acquire information sensed by the temperature sensor part, the controller being electrically connected to the damaging portion to control an operation of the damaging portion, and
wherein the controller is configured to:
damage the first reaction capsule by operating the damaging portion when a temperature detected by a temperature reference number of temperature sensor parts is a reference temperature or more.

12. The fluid storage apparatus of claim 5, wherein the impact absorbing part further includes:
a fire extinguishing capsule disposed in an interior of the impact absorbing portion, which is located on a lower side of the reference plane, and including a fire extinguishing agent for extinguishing fire in an interior thereof.

13. The fluid storage apparatus of claim 12, wherein the impact absorbing portion is formed of a material having a first melting temperature, and
wherein the fire extinguishing capsule is formed of a material having a second melting temperature greater than the first melting temperature.

14. The fluid storage apparatus of claim 13, further comprising:
a fire resistant part located on a lower side of the storage tanks, and covering the lower side of the storage tanks,
wherein a passing hole extends through the fire resistant part in an upward/downward direction and is configured such that the fire extinguishing capsule is passable therethrough.

15. The fluid storage apparatus of claim 14, wherein the passing hole is shaped such that a size tapers towards a lower side.

16. The fluid storage apparatus of claim 1, wherein a length of the impact absorbing part along the first direction is less than a length of the one or more storage tanks along the first direction.

17. The fluid storage apparatus of claim 1, wherein the one or more storage tanks include outlets on sides thereof in the first direction and a direction opposite thereto, and
wherein the storage part further includes:
a manifold coupled to outlets of the one or more storage tanks in the first direction, and an interior of which is communicated to interiors of the one or more storage tanks;
a bracket coupled to outlets of the one or more storage tanks in a direction opposite to the first direction, the bracket being configured to allow expansion of the one or more storage tanks in the direction opposite to the first direction, and an interior of the bracket is communicated with the interiors of the one or more storage tanks; and
a thermally activated pressure relief device connected to at least one of the manifold and the bracket.

18. The fluid storage apparatus of claim 1, further comprising:
a regulator connected to the storage part, and configured to reduce a pressure of a fluid in the one or more storage tanks, which is discharged from the one ore more storage tanks;
a fluid supply system connected to the regulator and configured to receive the fluid from the regulator and supply the fluid to a stack;
a fluid supply pipeline connecting the fluid supply system and the stack;
a fluid branch pipeline branched from the fluid supply pipeline and connected to the impact absorbing part; and
a fluid opening/closing valve configured to open and close the fluid branch pipeline.

19. The fluid storage apparatus of claim 18, wherein the impact absorbing part is a material coated for an anti-static effect.

20. The fluid storage apparatus of claim 1, further comprising:
a compressor configured to compress air introduced from an outside;
a cooler configured to cool the air discharged from the compressor;
an air supply pipeline connecting the compressor and the cooler;
an air branch pipeline branched from the air supply pipeline and connected to the impact absorbing part; and
an air opening/closing valve configured to open and close the air branch pipeline,
wherein a plurality of holes are formed on an outer surface of the impact absorbing part.
